(19) United States
(12) Patent Application Publication
(10) Pub. No.: US 2017/0283121 A1
(43) Pub. Date: Oct. 5, 2017

(54) EASY OPEN BAG

(71) Applicant: Roger Bannister, Bowling Green, KY (US)

(72) Inventor: Roger Bannister, Bowling Green, KY (US)

(21) Appl. No.: 15/085,941

(22) Filed: Mar. 30, 2016

(51) Int. Cl. B65D 30/20; B31B 37/00

(52) U.S. Cl. CPC B65D 31/10; B31B 37/00; B31B 2237/20; B31B 2219/603; B31B 2219/26

(57) ABSTRACT

A shipping bag or sack having side gussets, an easy open double fold, and tightly sealed stepped ends is described that withstands internally forces at the easy open end during drop tests. The side gussets include a stepped feature that may be incorporated into polywoven, thermoplastic and paper bags. The bags further include a two step fold and seal process.

### CROSS-REFERENCE TO RELATED APPLICATIONS

Not Applicable

### FEDERAL SPONSORSHIP

Not Applicable

### JOINT RESEARCH AGREEMENT

Not Applicable

### TECHNICAL FIELD

This invention pertains generally to side gusseted bags or sacks that are especially useful for both retailing and shipping bulk amounts of a product. More particularly, the invention pertains to a shipping bag or sack having side gussets and a double fold easy open top end that is capable of withstanding internal forces against a sealed easy open top end during drop tests. The invention further pertains to a side gusseted bag that includes a stepped feature at the easy open end that may be incorporated into polywoven, thermoplastic and paper bags. The manufacture of these bags includes two fold and seal process steps.

### BACKGROUND

Generally, traditional shipping bags have been assembled from a paper or poly woven sheet material that are formed into a tube and then sealed on the ends with an adhesive, thermal weld, or stitching. A seam adjoining the sides of the sheet material may be thermally welded or sealed with an adhesive. Pinch Bottom Open Mouth shipping sacks (sometimes referred to as “PBOM” bags) may be shipped from the bag manufacturer in a flattened condition with one end closed or sealed, and the other end open for filling the bag. A product packaging facility may incorporate these bags into their production line, using the open end to place or fill product into the bag. The open end of the sack is sometimes referred to by the bag manufacturer as the consumer end while the bottom closed end may be referred to by the bag manufacturer as the manufactured end. The open end of the bag may ultimately become either the top or the bottom of a bag that is filled with product and displayed for purchase by consumers. The product packaging facility may close or seal the open end with a desired fold or seal arrangement. At times, it may be desirable to provide one end of the bag with a means of easily opening the bag. The bag manufacturer may incorporate the easy open feature into the closed end of the bag that is sent from the bag manufacturer to the packaging facility. Alternatively, the packaging facility may seal the open end with an easy open feature once the bag is filled.

Also, when shipping or displaying bulk amounts of a product it may be desirable to include an amount of the bulk material contained within the bags that exceeds thirty pounds. The bags may be gusseted so that they lay flat in storage but expand to contain the larger quantities of bulk material. The heavier materials contained within the bag further requires a sealed or closed bag capable of withstanding heavier loads. Sealing the end that a consumer opens with a seal that withstand heavy loads may be in conflict with a desire to provide an end that opens easily. Prior bags have provided zippers or cover tape and stitching to allow easier access to the interior of the bag. In practice, users may simply cut open the bag to gain access to the interior, however, the cutting of the bag results in fragments contaminating the contents of the bag.

### SUMMARY

Embodiments according to aspects of the invention provides a uniquely stepped and folded top opening of a side gusseted easy open double fold bag or sack. The shipping bag or sack of the present invention is especially useful for both retailing and shipping bulk amounts of a product. When the easy open double fold of the bag is sealed, the bag is capable of withstanding internal forces at the easy open end from multiple drops during a drop test. The embodiments according to aspects of the invention further include a stepped feature that may be incorporated into polywoven, thermoplastic and paper bags.

These and other embodiments according to aspects of the invention include a bag or sack for holding heavy bulk product. The bag may be made from a polywoven, thermoplastic or paper sheet material, having opposing front and back panels, interconnecting opposing sides, and opposed ends. The interconnecting opposing sides of the bag interconnect the front and back panels. The opposing sides are formed from opposing gussets that extend longitudinally between the top and bottom opposed ends of the bag. The gussets include first and second gusset folds and an intermediate gusset fold. The first gusset fold extends inward from an outer longitudinal edge of the back panel, the second gusset fold extends inward from an outer longitudinal edge of the front panel, and the intermediate gusset fold extends longitudinally and transitions and interconnects the first gusset fold with the second gusset fold. The back panel, first gusset fold, second gusset fold and front panel each include a top edge, wherein the top edges of each are aligned together in a stepped fashion. Also, the top end of the intermediate gusset fold has a slope that interconnects the top ends of the first and second gusset folds.

Aspects of the invention may include a bag formed from a sheet material having a seam in the bag formed by overlapping side edges of the sheet material. An easy open end is formed in the bag wherein a portion of the back panel near the top end of the back panel includes a first lateral crease intersecting the slope of the intermediate gusset fold and extends laterally between the opposing sides of the bag. The front panel and a portion of the back panel may further include a second lateral crease that extends laterally between the opposing sides below the top end of the front panel. According to certain aspects of the invention, the back panel may fold along the first lateral crease such that the back panel folds onto itself and a first thermal weld adheres a portion the back panel to an adjacent portion of the back panel. Additionally, the folded portion of the back panel may be further folded along a second lateral crease such that the folded portion of the back panel overlaps the front panel and is thermal welded and engaged to an upper portion of the front panel.

Another embodiment according to aspects of the invention includes an easy open shipping sack having opposing front and back panels, interconnecting opposing sides, and opposed ends. The interconnecting opposing sides interconnect the front and back panels with opposing gussets, wherein the gussets extend longitudinally between the first and second opposed ends. Each gusset includes a first gusset, second gusset fold and an intermediate gusset fold. The first gusset fold extends inward from an outer longitudinal edge of the back panel, the second gusset fold extends inward from an outer longitudinal edge of the front panel, and an intermediate gusset fold transitions and interconnects the first gusset fold with the second gusset fold. The open top end is stepped so that a top end of the back panel, first gusset fold, second gusset fold and front panel all align with respect to each other in a stepped fashion. The top end of the intermediate gusset fold has a slope greater than zero and less than 1 extending between the top end of the first gusset fold and the top end of the second gusset fold. A portion of the back panel near the top end of the back panel includes a first lateral crease intersecting the slope of the intermediate gusset fold and extends laterally between the opposing sides of the bag. Also, the back panel folds along the first lateral crease such that the back panel folds onto itself and a first thermal weld adheres a portion the back panel to an adjacent portion of the back panel. Additionally, a portion of the front panel and a portion of the back panel may include a second lateral crease that extends laterally between the opposing sides below the top end of the front panel. The folded portion of the back panel may be folded along the second lateral crease such that the folded portion of the back panel overlaps the front panel and may be thermally welded and engaged to an upper portion of the front panel.

According to aspects of the invention an easy open double fold bag is formed by conveying a sheet material through a bag forming and separation units. Those skilled in the art will appreciate that each bag may be made from a pre-sized sheet of material, however, the manufacturing process may be enhanced with the use of rolled sheet material. Without limitation the bag forming and separation unit may utilize a cutting die or shaped knives having a defined step arrangement to cut or perforate a stepped pattern into the sheet material. An alternative suitable method of cutting utilizes a programmable laser to cut the stepped pattern into the sheet material. During formation of the bag, the side edges of the sheet material are overlapped to form a tube of an overlapped sheet material having opposing sides, a front panel, and a back panel. Gussets are formed on the opposing sides of the overlapped sheet material in a manner so that each gusset includes a first gusset fold extending inward from an outer longitudinal edge of the back panel, a second gusset fold extending inward from an outer longitudinal edge of the front panel, and an intermediate gusset fold extending longitudinally that transitions. The intermediate gusset fold interconnects the first gusset fold with the second gusset fold, wherein a top end of the intermediate gusset fold has a slope greater than zero and less than one extending between the top end of the first gusset fold and the top end of the second gusset fold. The top ends of the back panel, first gusset fold, second gusset fold and front panel are aligned with the cut steps aligned in a stepped fashion. The overlapping edges of the overlapped sheet material are sealed together with a hot melt, adhesive or weld.

The process of forming the bag may further include the step of folding a portion of the back panel near the top end of the back panel along a first lateral crease that intersects the slope of the intermediate gusset fold and extends laterally between the opposing sides of the bag. Additionally, the process of forming the bag may include the step of folding a portion of the front panel and a portion of the back panel along a second lateral crease that extends laterally between the opposing sides below the top end of the front panel. Further, when folding the back panel along the first lateral crease, the fold line or crease intersects the slope of the intermediate gusset. Once folded, the back panel is thermally welded onto itself.

Alternatively, the method of forming the bag may further include the steps of folding the back panel along a first lateral crease such that the back panel folds onto itself; thermally welding a portion the back panel to an adjacent portion of the back panel to form a folded portion of the back panel; folding the folded portion of the back panel along a second lateral crease such that the folded portion of the back panel overlaps the front panel; and thermally welding the folded portion of the back panel to an upper portion of the front panel.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components.

FIG. 1 is a front view of a shipping bag apparatus of the present invention illustrating the two fold lines or creases and the two thermal weld lines;

FIG. 2 is an enlarged front view of a top portion of a bag illustrating a single fold and thermal weld;

FIG. 3 is an enlarged front view of a top portion of the shipping bag apparatus of the type shown in FIG. 1;

FIG. 4 is a top view of a continuous sheet material having cut patterns and gusset fold lines to form the assembled shipping bag apparatus of the present invention;

FIG. 5 is an enlarged front view of a top portion of the sheet material illustrating a first inward fold of one of the gussets of the shipping bag apparatus of the present invention shown during the manufacturing process;

FIG. 6 is an enlarged front view of a top portion of the sheet material illustrating an intermediate fold of one of the gussets of the shipping bag apparatus of the present invention shown during the manufacturing process;

FIG. 7 is an enlarged front view of a top portion of the sheet material illustrating a second inward fold of one of the gussets of the shipping bag apparatus of the present invention shown during the manufacturing process;

FIG. 8 is an enlarged front view of a top portion of a shipping bag apparatus of the present invention illustrating the fold lines, creases, and thermal weld lines of an assembled shipping bag apparatus of the present invention;

FIG. 9 is an enlarged front view of a top portion of a shipping bag apparatus of the present invention illustrating the fold lines, creases, and thermal weld lines during the assembling of the shipping bag apparatus of the present invention and illustrating the back panel folded onto itself; and

FIG. 10 is an enlarged front view of a top portion of a shipping bag apparatus of the type shown in FIG. 9 illustrating the folded portion folded a second time to engage a front portion of the front panel and illustrating the folds, creases, and thermal weld lines of an assembled shipping bag apparatus of the present invention.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

The apparatus 10 of the present invention is particularly well suited for shipping or retailing heavy bulk product. The shipping bag 10 includes a front panel 12, back panel 16, and opposing sides 20. The bottom end 32 of the bag may be flush cut or left with the opposing mirroring step that is created during a step pattern cut manufacturing process that is described below in greater detail. Although a die cutting process and die cut pattern are described, those skilled in the art will appreciate that the stepped pattern that is cut into a top end 34 of the bag may be accomplished with a programmable laser cutting tool of known suitable construction. The bottom end 32 may be sealed with a double fold and then adhered to the bag with an adhesive, glue, heat seal, weld or other known sealing or closing. Further, the bottom may be sewn with or without bound over tape. The tape and thread of the sewn closure may be dipped in a sealing compound to reduce moisture entering through the sewn seam. Referring to the Figures, various embodiments according to aspects of the invention will be described in greater detail.

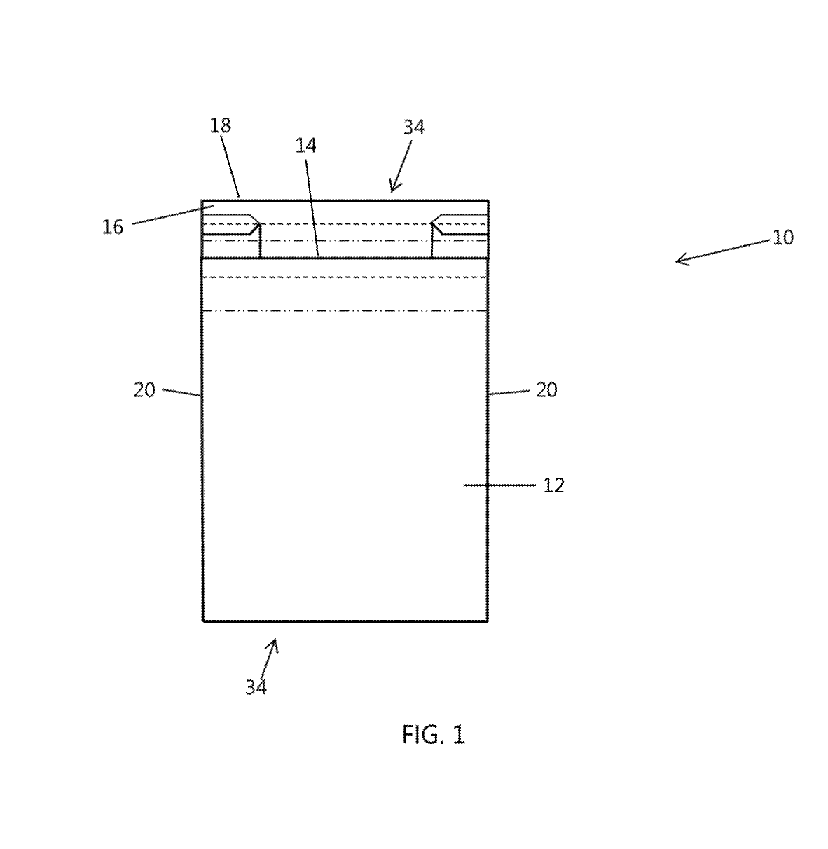

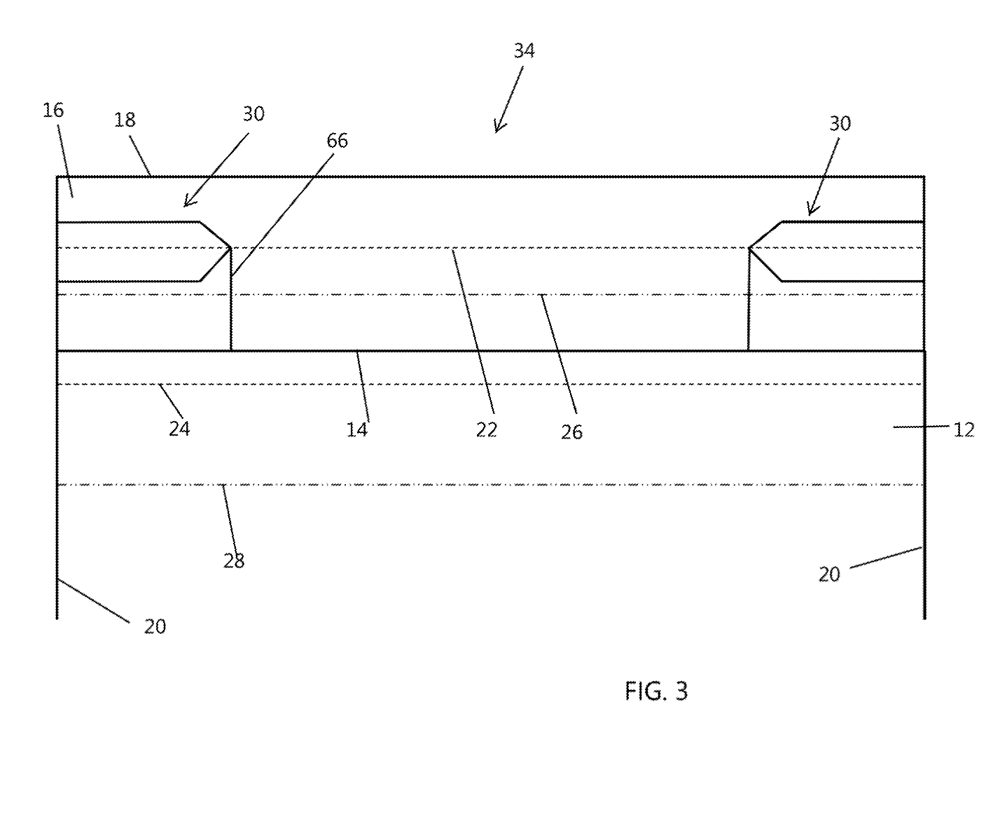

With reference to FIGS. 1 and 3, the shipping bag 10 is shown having front panel 12, back panel 16 and opposing sides 20. Front panel 12 has a top end or edge 14 and back panel 16 has a top end or edge 18. The opposing sides 20 include opposing gussets 30. Each gusset 30 includes a first fold 40, second fold 50, and intermediate fold 60. The gusset folds 30, 40 and 50 extend longitudinally from the top of the bag 34 to the bottom of the bag 32. The folds are oriented in a stepped relation that is described below in greater detail. The gussets 30 allows the empty bags to be stored flat, but the front and back panels may be separated to expand the gussets and allow contents to be placed between the front and back panels. Once the bag has been filled through the open top end of the bag the top end may be folded and sealed twice along the lateral first fold line or crease 22, first thermal weld line 26, second fold line or crease 24 and second thermal weld line 28. Alternatively, the bag manufacturer or other user of the present invention may fold and seal the top 34 of the bag (as described herein) and then fill the bag through the bottom 32 prior to sealing the bottom with a pinch or sewn seal.

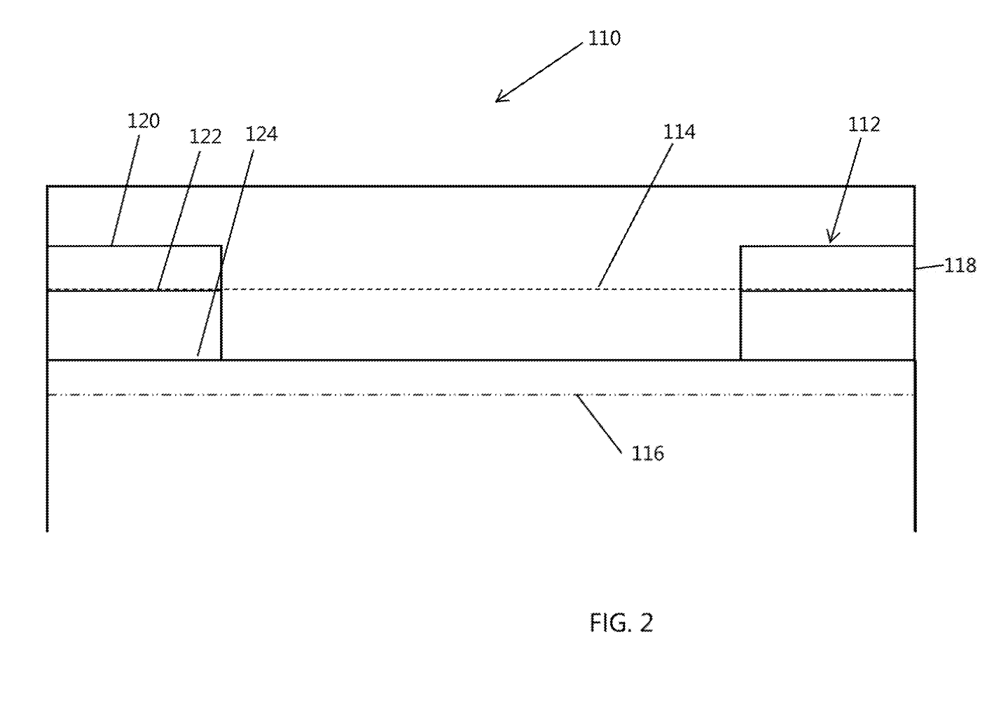

FIG. 2 illustrates a side gusseted bag 110 having a stepped top end 112 and a single fold or crease 114 and single weld 116. Steps are formed between first fold 120, intermediate fold 122 and second fold 124. Steps in the folded portion of the gusset are preferred to increase the amount of gusset surface that is sealed in the folded region. Although deep steps may increase the ability to ensure a complete seal of the gusset, the deeper the step the more sheet material is required to manufacture the bag; thereby increasing the cost to manufacture the bag. As an alternatively to stepping the top end of the gusset, the gusset bag may be folded over and preferably sewn and taped to ensure that the gusset portion is sealed. The sewn portion may increase cost, manufacturing complexity, and increase the likely of moisture leaks into the bag. Further, each of the steps formed at the top end of the bag form 90 degree angles 188. The 90 degree angled steps could be described as having a slope of zero or one, but could not accurately be described as having a slope between zero and one. The lateral fold line 114 is shown aligned adjacent the top edge of the intermediate fold 122. The back panel of bag 110 is folded along fold line 114 and the top folded portion of the back panel is engaged with the front panel below the top edge of the front panel. In this manner the folded portion seals the bag 110 but requires a tearing or cutting of the bag to access the interior.

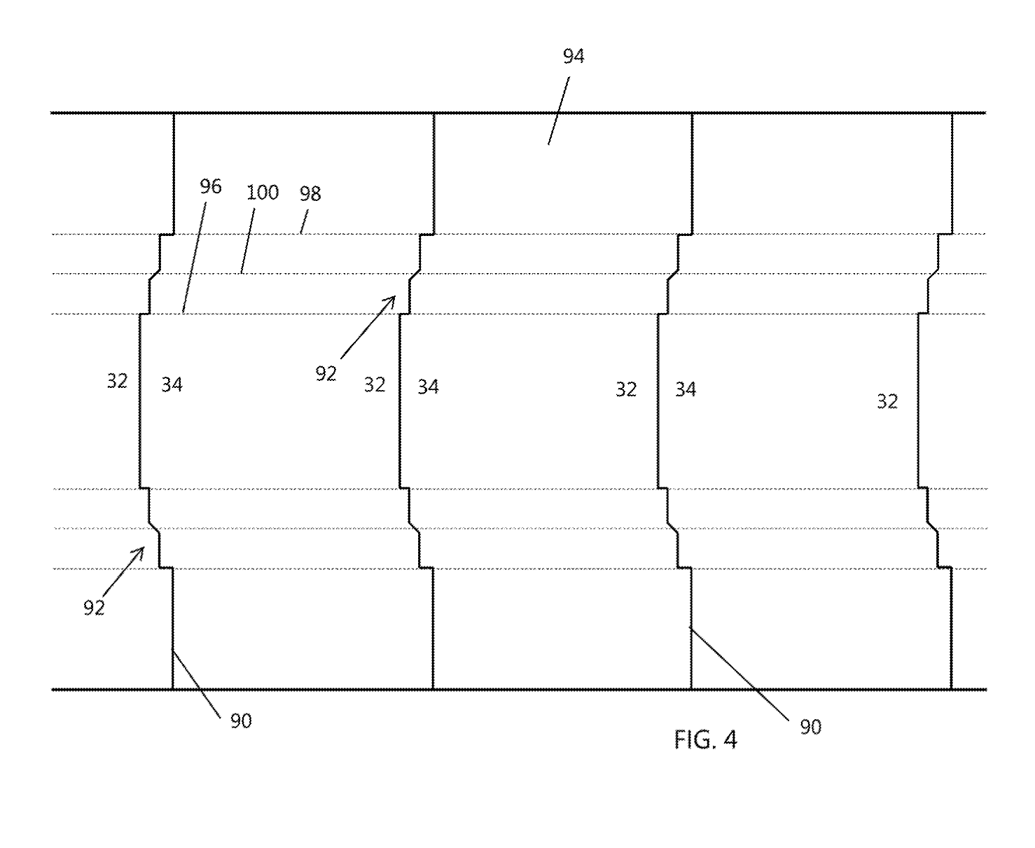

FIG. 4 illustrates multiple shipping bags 10, during the process of manufacture, having perforations or cuts 90 to separate the individual bags 10 from a continuous sheet material 94. The cuts or perforations 90 divide the shipping bags and allow the bags formed on the roll to be simply separated and detached from the sheet material. Stepped cut pattern 92 defines the fold lines 96, 98, and 100 for the first fold, second fold, and intermediate fold. The slope 64 of the top end 62 of the intermediate fold 60 is formed in the cut pattern 92. When the bag 10 is separated from the roll the gussets 30 are formed to define the opposing sides 20 of the bag.

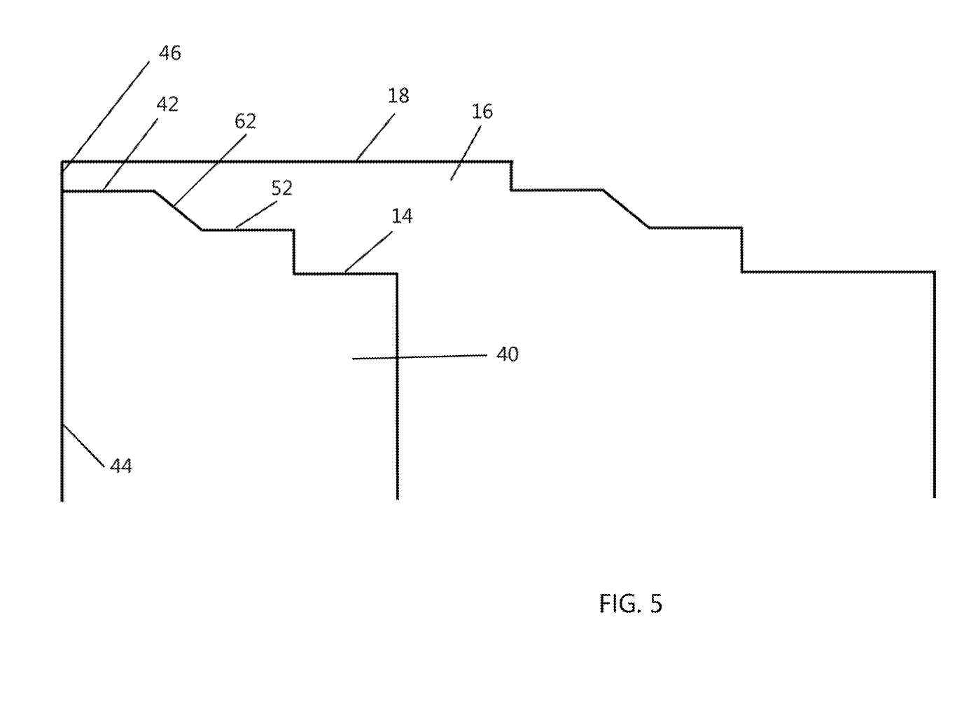

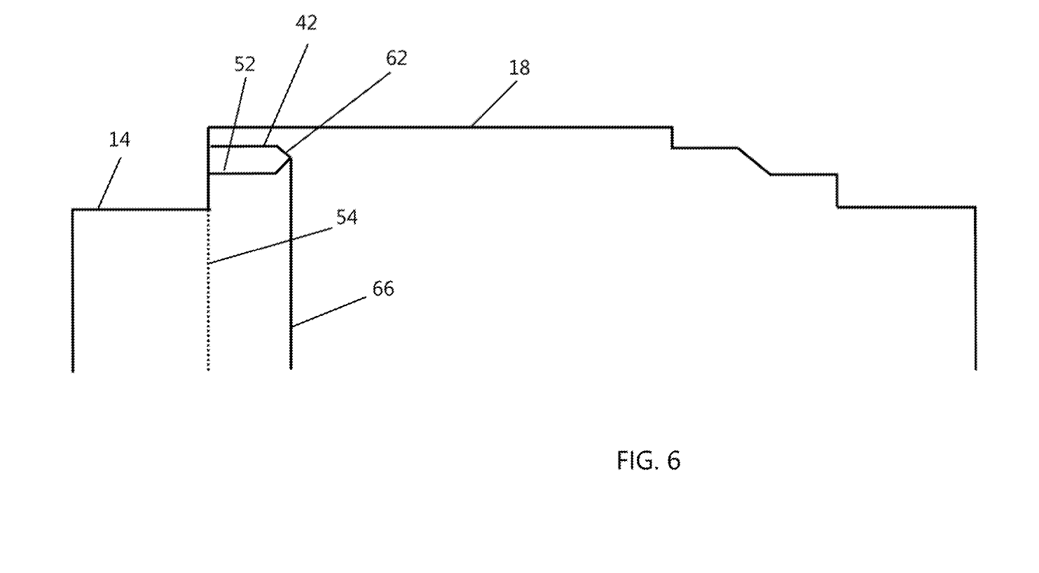

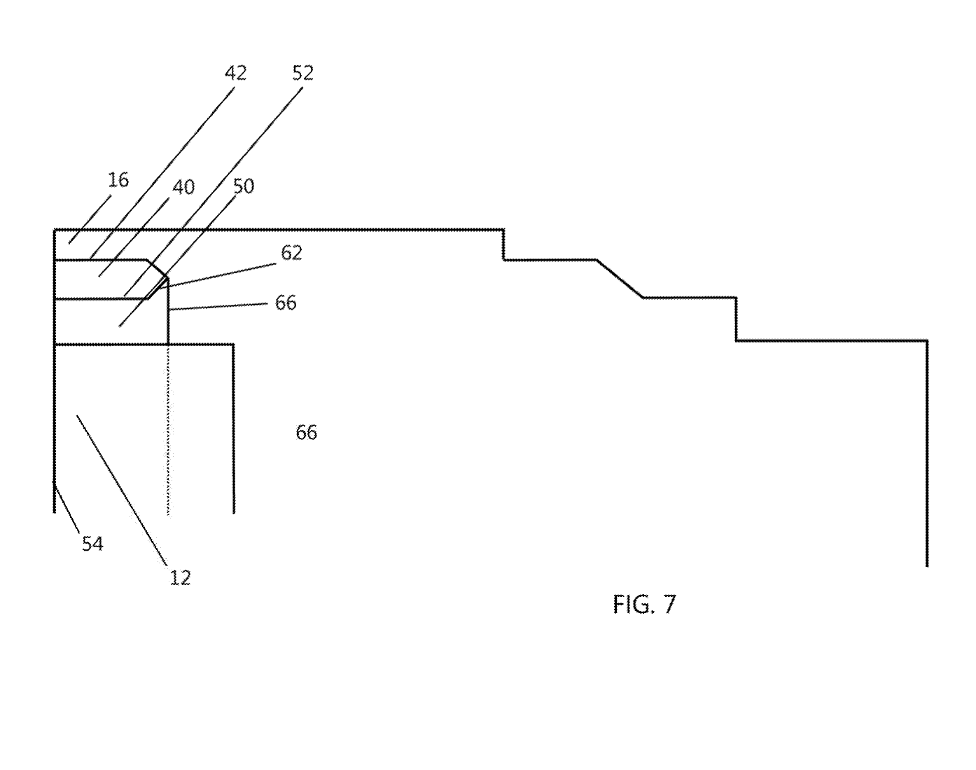

Referring to FIGS. 5-7 the formation of the gussets 20 is illustrated. Those familiar with bag forming machines will appreciate that the folding of the first and second gusset folds 40 and 50 occurs simultaneously rather than sequentially, however for illustrative purposes the folds will be described sequentially. Further, those skilled in the art will appreciate that the opposing gussets may be formed approximately simultaneously after the sheet material forms a tube rather than folding the gusset folds individually as depicted in FIGS. 5-7. For ease of discussion, the folding process will be described as sequential folding rather than simultaneous folding. The first gusset fold 40 folds inward (see FIG. 5) along the fold line 96 from the first fold edge 44 intersecting longitudinally the back panel 16 and first fold 40. The first gusset fold 40 has a top end 42 of the fold. The depth of the step defined between the top end of the back panel and the top end 42 of the first fold may range between 12 and 14 mm with 13 mm being preferred. Second gusset fold 50 folds inward (see FIG. 7) along the fold line 98 from the second fold edge 54 intersecting longitudinally the front panel 12 and second fold 50. The second gusset fold 50 has a top end 52 of the fold. The depth of the step defined between the top end 14 of the front panel 12 and the top end 52 of the second fold 50 may range between 19 and 21 mm with 20 mm being preferred. Intermediate gusset fold 60 transitions and interconnects the first fold 40 and the second fold 50 (see FIG. 6) along the fold line 100. The intermediate gusset 60 has a top end 62 that slopes downward from the top end of the first fold 40 to the top end 52 of the second fold 50. The slope 64 may range between zero and one but is neither zero nor one. The edge 66 formed along crease 100 intersects the slope 64 forming the top end 62 of the intermediate gusset 60. The depth of the step (rise of the slope) defined between the top end 42 of the first fold 40 and the top end 52 of the second fold 50 may range between 16 and 18 mm with 17 mm being preferred.

The preferred range of depths for the first fold, second fold, and intermediate fold have been described for large gusset bags, wherein the overall width of material used to form the gusset (measured between the longitudinal folds) is approximately 150 mm. Those skilled in the art will appreciate that other bag sizes may use different sized gussets, ranging for example between 60 mm to 200 mm for example, wherein the step dimensions are accordingly scaled. By way of example, a gusset having a width between the longitudinal folds measuring approximately 110 mm may have the depth of the first gusset fold step ranging between 10-12 mm, the depth of the second gusset fold step ranging between 17-19 mm, and the depth of the intermediate gusset fold rise ranging between 15-17 mm. The width of the corresponding first lateral fold ranges between 15-19 mm and the width of the lateral second fold ranges between 26-32 mm.

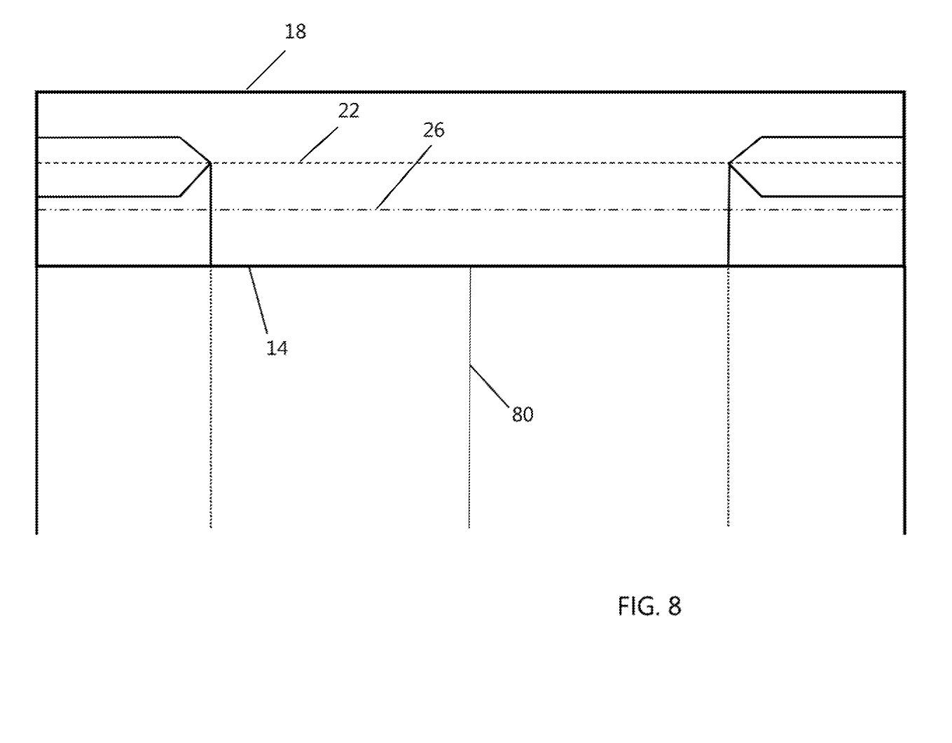

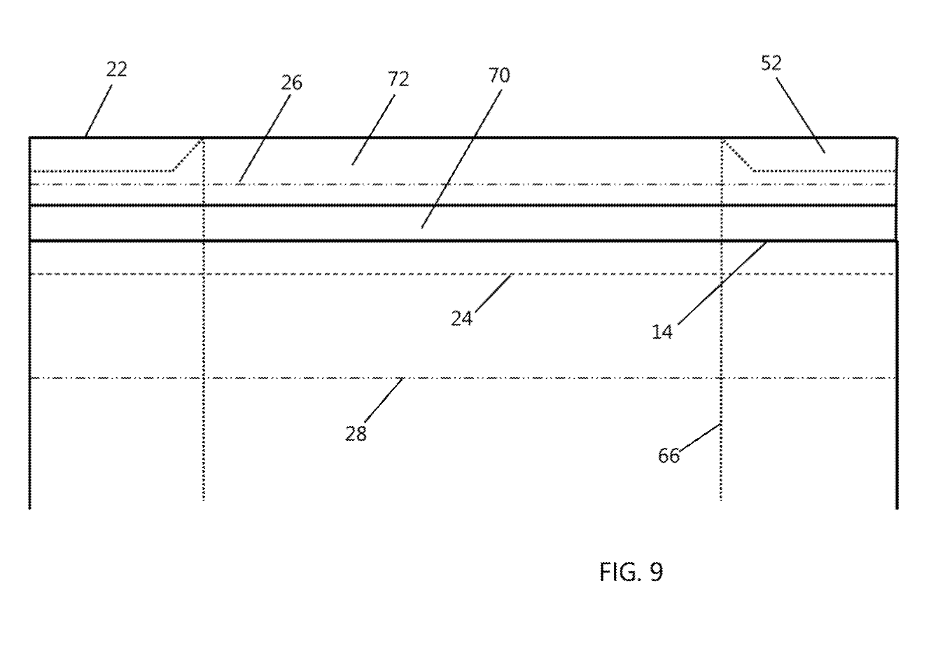

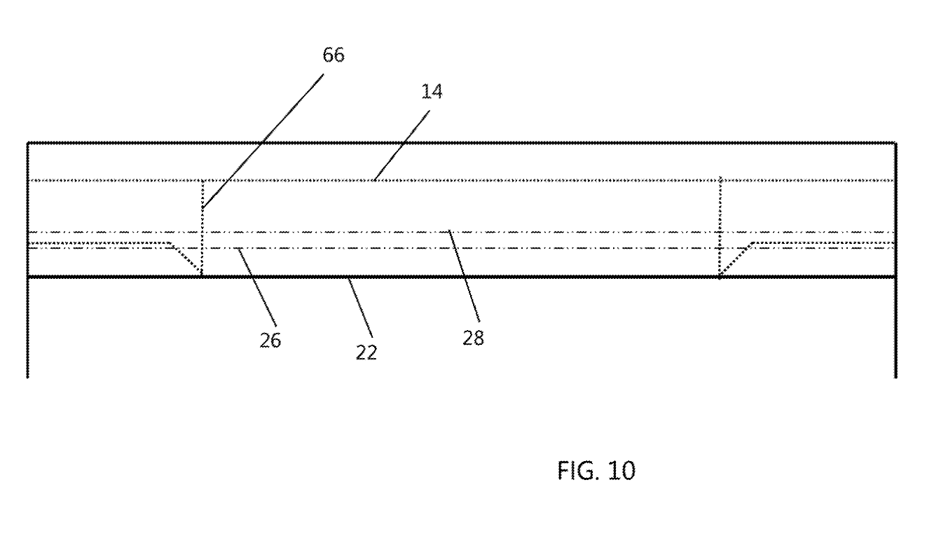

FIGS. 8-10 illustrates the two fold and seal process for the easy open stepped bag 10 in accordance with various aspects of the invention. The overlapping longitudinal edge of the two portions of the front panel are thermal welded to form seam 80 in the bag (shown in FIG. 8). The position of the seam may be varied by increasing or decreasing the width of the left or right portions of the front panel. FIG. 9 illustrates a first folded portion 72 of the back panel 16 that overlaps onto and adjacent portion 70 of the back panel. The first folded portion may have a width ranging between 20 to 25 mm. According to an aspect of the invention, the folded portion 72 is thermal welded along thermal weld line 26 in unison with the folding of the top portion of the back panel. The first thermal weld 26 is characterized as having an inseparable strength, bonding the two surfaces together.

It should be appreciated that the sealing or closing of the ends of the bag may be accomplished by welding (ultrasonic, heat, laser, thermal welding, etc.), adhering, taping, stitching, or sealing dependent upon whether a polywoven, thermoplastic or paper material is used to form the bag. By way of example, and without limitation intended, the closing of the bag may be accomplished by conveying the bag through a folding and sealing device, wherein the folding device folds a top or bottom of the bag as the bag moves in a downstream direction. At the downstream end of the folding device, a welding device associated with the folding device welds the folder over end of the bag. Such a folding and welding device has been described by Miller Weldmaster Corporation of Navarre, Ohio. It will be appreciated that the sealing method that is utilized will primarily depend upon the material used to form the bag.

Those skilled in the art will appreciate that the easy open fold and seal of the present invention may be incorporated into the bag by the manufacture of the bag, with the easy open fold and seal forming the closed end and a pinch seal applied by the packaging facility after filling the bag. Alternatively, the bag manufacturer may apply a pinch and seal to form the closed bottom of the bag and the packaging facility may form the easy open fold and seal at the top of the bag after filling the bag. For discussion purposes, and without limitation intended, the bag of the present invention is described herein having a pinch bottom and easy open fold and seal top end. The bag may be filled through the open end by extending or pulling the top end 14 of the front panel 12 away from the back panel 16. The folded portion 72 is then folded along fold line 24 to form a second folded portion 74 and a second thermal weld 28 is applied approximately simultaneously with the folding of the folded portion. The second folded portion may have a width ranging between 28 to 35 mm. The second fold 74 forms an easy open flap that allows a user to grasp an edge portion and separate the second folded portion 74 from the front panel.

Although the bond between the second fold and the front panel allows for separation of the second fold and the front panel, the lateral fold intersecting the slope of the intermediate fold, together with the thermal weld that bonds the back panel to itself and the second fold 50, and the overlapping of the second fold onto the front panel, provides a sealed end that withstand the internal force of contents pressing against the inner walls of the bag during drop tests. By way of example, bags having a stepped construction similar to the bag shown in FIG. 2 were filled with 25 Kg of material and then folded and sealed. The bag was then held from 15 feet and dropped 15 times. This drop test was repeated on 10 bags. One out of ten bags showed slight leaks or small ruptures in the weld. Bags having the stepped construction with a sloped intermediate fold as illustrated in FIG. 1 and FIGS. 3-10 were tested with a more aggressive drop test and resulted in zero failures. These bags in accordance with the present invention were filled with 25 Kg of the same material and then folded and sealed as described above. The bag was then held from 20 feet and dropped 20 times. This drop test was repeated on 10 bags with no observed leaks or weakening in the weld.

Having described the constructional features of the invention the method of manufacture will now be described. In accordance with aspects of the invention, forming an easy open shipping sack of the present invention begins with conveying a sheet material through a cutter. The sheet material may be comprised of a polywoven, thermoplastic or paper material of known suitable construction. The cutting of the sheet material may utilize a die, for example, having a stepped die cut pattern. The sheet material is then conveyed through a former that overlaps the side edges of the sheet material to form an overlapped sheet material having opposing sides, a front panel, and a back panel. The former also forms opposing gussets on the opposing sides. Each gusset is formed to include a first gusset fold extending inward from an outer longitudinal edge of the back panel, a second gusset fold extending inward from an outer longitudinal edge of the front panel, and an intermediate gusset fold extending longitudinally that transitions and interconnects the first gusset fold with the second gusset fold. The top end of the intermediate gusset fold is cut having a slope greater than zero and less than one extending between the top end of the first gusset fold and the top end of the second gusset fold. When the gusset fold overlap the top end of the back panel, top end of the first gusset fold, top end of the second gusset fold and top end of the front panel align in a stepped fashion. The overlapping edges of the overlapped sheet material are adhered or sealing together.

In an embodiment of the invention, the stepped top is folded along a lateral fold line so that a portion of the back panel near the top end of the back panel folds along a first lateral crease that intersects the slope of the intermediate gusset fold and extends laterally between the opposing sides of the bag. A portion of the front panel and a portion of the back panel may be further folded along a second lateral crease that extends laterally between the opposing sides below the top end of the front panel. The folded portion is thermally welded or otherwise adhered so that the back panel attaches to itself. Alternatively, the process may include folding the back panel along a first lateral crease such that the back panel folds onto itself, thermally welding a portion the back panel to an adjacent portion of the back panel to form a folded portion of the back panel, folding the folded portion of the back panel along a second lateral crease such that the folded portion of the back panel overlaps the front panel; and thermally welding the folded portion of the back panel to an upper portion of the front panel.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. An easy open shipping sack apparatus for holding bulk product, the apparatus comprising:
a bag having opposing front and back panels, interconnecting opposing sides, and opposed ends, wherein said interconnecting opposing sides interconnect said front and back panels with opposing gussets, said gussets extending longitudinally between the first and second opposed ends;
each said gusset includes a first gusset fold extending inward from an outer longitudinal edge of said back panel, a second gusset fold extending inward from an outer longitudinal edge of said front panel, and an intermediate gusset fold extending longitudinally that transitions and interconnects said first gusset fold with said second gusset fold;
a top end of said back panel, top end of said first gusset fold, top end of said second gusset fold and top end of said front panel all of which are aligned in stepped fashion; and
a top end of said intermediate gusset fold having a slope greater than zero and less than one between the top end of said first gusset fold and the top end of said second gusset fold.

2. The apparatus as recited in claim 1, wherein a portion of the back panel near the top end of the back panel includes a first lateral crease intersecting the slope of the intermediate gusset fold and extending laterally between the opposing sides of the bag.

3. The apparatus as recited in claim 2, wherein a portion of the front panel and a portion of the back panel includes a second lateral crease that extends laterally between the opposing sides below the top end of the front panel.

4. The apparatus as recited in claim 1, wherein said back panel folds along a first lateral crease such that the back panel folds onto itself and a first thermal weld adheres a portion the back panel to an adjacent portion of the back panel.

5. The apparatus as recited in claim 1, wherein said back panel folds along a first lateral crease such that the back panel folds onto itself and a first thermal weld engages a portion the back panel to an adjacent portion of the back panel to form a folded portion of the back panel, and further wherein the folded portion of the back panel is further folded along a second lateral crease such that the folded portion of the back panel overlaps the front panel and is thermal welded and engaged to an upper portion of the front panel.

6. The apparatus as recited in claim 1, wherein a first step is formed between the top end of said back panel and the top end of said first gusset fold having a depth ranging between 12 and 14 mm.

7. The apparatus as recited in claim 6, wherein a second sloped step is formed between the top end of said first gusset fold and the top end of said second gusset fold having a depth ranging between 16 and 18 mm.

8. The apparatus as recited in claim 7, wherein a third step is formed between the top end of said second gusset fold and the top end of said front panel having a depth ranging between 19 and 21 mm.

9. An easy open shipping sack apparatus for holding bulk product, the apparatus comprising:
a bag having opposing front and back panels, interconnecting opposing sides, and opposed ends, wherein said interconnecting opposing sides interconnect said front and back panels with opposing gussets, said gussets extending longitudinally between the first and second opposed ends;
each said gusset includes a first gusset fold extending inward from an outer longitudinal edge of said back panel, a second gusset fold extending inward from an outer longitudinal edge of said front panel, and an intermediate gusset fold extending longitudinally that transitions and interconnects said first gusset fold with said second gusset fold;
a top end of said back panel, top end of said first gusset fold, top end of said second gusset fold and top end of said front panel all of which are aligned in stepped fashion;
a top end of said intermediate gusset fold having a slope greater than zero and less than 1 between the top end of said first gusset fold and the top end of said second gusset fold;
wherein a portion of the back panel near the top end of the back panel includes a first lateral crease intersecting the slope of the intermediate gusset fold and extending laterally between the opposing sides of the bag and wherein said back panel folds along said first lateral crease such that the back panel folds onto itself and a first thermal weld adheres a portion the back panel to an adjacent portion of the back panel; and
wherein a portion of the front panel and a portion of the back panel includes a second lateral crease that extends laterally between the opposing sides below the top end of the front panel.

10. The apparatus as recited in claim 9, wherein the folded portion of the back panel is further folded along said second lateral crease such that the folded portion of the back panel overlaps the front panel and is thermal welded and engaged to an upper portion of the front panel.

11. The apparatus as recited in claim 9, wherein a first step is formed between the top end of said back panel and the top end of said first gusset fold having a depth ranging between 12 and 14 mm.

12. The apparatus as recited in claim 11, wherein a second sloped step is formed between the top end of said first gusset fold and the top end of said second gusset fold having a depth ranging between 16 and 18 mm.

13. The apparatus as recited in claim 12, wherein a third step is formed between the top end of said second gusset fold and the top end of said front panel having a depth ranging between 19 and 21 mm.

14. A method of forming an easy open shipping sack apparatus for holding bulk product, said method comprising the steps of:
conveying a sheet material;
cutting the sheet material with a stepped pattern;
overlapping side edges of the sheet material to form an overlapped sheet material having opposing sides, a front panel, and a back panel;
forming opposing gussets on the opposing sides, each said gusset including a first gusset fold extending inward from an outer longitudinal edge of the back panel, a second gusset fold extending inward from an outer longitudinal edge of the front panel, and an intermediate gusset fold extending longitudinally that transitions and interconnects said first gusset fold with said second gusset fold, wherein a top end of said intermediate gusset fold having a slope greater than zero and less than one extending between the top end of said first gusset fold and the top end of said second gusset fold;
aligning a top end of said back panel, top end of said first gusset fold, top end of said second gusset fold and top end of said front panel in a stepped fashion; and
adhering or sealing together the overlapping edges of the overlapped sheet material.

15. The method according to claim 14, further including the step of folding a portion of the back panel near the top end of the back panel along a first lateral crease that intersects the slope of the intermediate gusset fold and extends laterally between the opposing sides of the bag.

16. The method according to claim 15, further including the step of folding a portion of the front panel and a portion of the back panel along a second lateral crease that extends laterally between the opposing sides below the top end of the front panel.

17. The method according to claim 14, further including the steps of folding said back panel along a first lateral crease that intersects the slope of the intermediate gusset and thermally welding the back panel onto itself.

18. The method according to claim 14, further including the steps of:
folding the back panel along a first lateral crease such that the back panel folds onto itself;
thermally welding a portion the back panel to an adjacent portion of the back panel to form a folded portion of the back panel;
folding the folded portion of the back panel along a second lateral crease such that the folded portion of the back panel overlaps the front panel; and
thermally welding the folded portion of the back panel to an upper portion of the front panel.
